(19) United States
(12) Patent Application Publication
(10) Pub. No.: US 2009/0324808 A1
(43) Pub. Date: Dec. 31, 2009

(54) METHOD OF REMOVING UNWANTED SULPHUR COMPOUNDS FROM THE INSULATING OIL OF AN ELECTRICAL APPARATUS

(75) Inventors: Karin Gustafsson, Sollentuna (SE); Robert Leandersson, Vasteras (SE)

Correspondence Address: VENABLE LLP, P.O. BOX 34385, WASHINGTON, DC, 20043-9998, US

(73) Assignee: ABB RESEARCH LTD, Zurich (CH)

(21) Appl. No.: 12/438,768

(22) PCT Filed: Aug. 13, 2007
(86) PCT No.: PCT/SE2007/050548

§ 371 Date: Feb. 25, 2009

(30) Foreign Application Priority Data
Aug. 25, 2006 (SE) 0601744-6
May 28, 2007 (SE) 0701284-2

(51) Int. Cl. B05D 5/12

(52) U.S. Cl. 427/58

(57) ABSTRACT

A method of treating copper sulfide deposits on materials and surfaces that are in contact with electrically insulating oil inside an electrical apparatus. The copper sulfide deposits on materials and surfaces are subjected to treatment with an iodine compound causing a substitution reaction with the copper sulfide.

### TECHNICAL AREA

The present invention relates to a method of treating copper sulphide deposits present in electrically insulating layers in an electrical apparatus.

### TECHNICAL BACKGROUND

Insulating oils are used in a number of different apparatus in the field of electrical power transmission and electrical power generation, for example; power transformers, distribution transformers, tap changers, switchgear and reactors.

These electrically insulating oils often contain traces of reactive sulphur compounds, which may react with copper, forming copper sulphide (Cu₂S). Copper sulphide is insoluble in oil and may form deposits on surfaces and materials in contact with the electrically insulating oils inside the electrical apparatus. The copper sulphide is a semiconductor and the formation of a semi-conducting deposit on surfaces and materials in the electrical apparatus may degrade or disrupt the operation of the apparatus.

If the semi-conducting copper sulphide is deposited on the isolation material (usually cellulose material e.g. paper) used to cover the copper conductors in the electrical apparatus, this might lead to a degrading of the insulation properties of the isolation material which could lead to leak currents or short circuits. Semi-conducting copper sulphide deposits on surfaces of solid isolation materials (such as wood, ceramic, and pressboard) inside the electrical apparatus may also create similar problems.

Semi-conducting copper sulphide deposits directly on surfaces of conductors may create problems, especially if the deposits are formed on connector surfaces.

CIGRE Moscow symposium 2005 “Oil corrosion and Cu2S deposition in Power Transformers”; Bengtsson et al. describes the results of failure analysis and a laboratory reproduction of the copper sulphide Cu₂S deposits on surfaces and materials in power transformers.

WO2005115082 entitled “Method for removing reactive sulfur from insulating oil” describes a method for removing sulphur-containing compounds from insulating oil by exposing the oil to at least one sulphur scavenging material and exposing the oil to at least one polar sorbent.

The method in WO2005115082 was developed for treating the electrically insulating oil, removing sulphur-containing compounds in the oil outside of the electrical apparatus which prevents further depositions of copper sulphide on materials and surfaces inside the electrical apparatus. Up to date there is no suggestion of how to treat copper sulphide that has already been deposited on surfaces and materials inside of the electrical apparatus. Currently, the only solution for removal of the depositions of copper sulphide on the insulation paper used to cover copper conductors is to remove the old paper and replace it with new insulation paper.

JP2001311083 describes how sulfur compounds in electrically isolation oils can be removed before the use in an electrical apparatus by storing the oil in a vessel containing copper or copper alloys. The sulfur compounds in the oil react with the copper and are thus captured and removed from the oil prior to the use in the electrical apparatus.

### SUMMARY OF THE INVENTION

One embodiment of the present invention is to provide a method by means of which semi-conducting copper sulphide deposits on materials and surfaces inside an electrical apparatus are treated with a halogen compound in oil.

An object of a preferred embodiment of the present invention is to provide a method by means of which copper sulphide deposits on materials and surfaces inside an electrical apparatus are treated.

One or more objects of the invention is achieved by means of the initially defined method, characterized in that a iodine compound causing a reaction of said copper sulphide deposits on materials and surfaces inside an electrical apparatus. The copper sulphide is a semiconductor and the formation of a semi-conducting deposit on the isolation material might lead to a degrading of the insulation properties of the insulating material and oil system which could lead to short circuits in the electrical apparatus. These short circuits can be avoided by removing the copper sulphide from the isolation material or transforming the copper sulphide to compounds with lower conductivity.

According to an embodiment said iodine compound comprises iodine in elementary form (I₂), according to another embodiment said iodine compound comprises hydrogen iodide (HI) and according to another embodiment said iodine compound comprises alkyl iodide (R—I). One embodiment of the present invention is that the iodine compound is added to the electrical insulation oil.

According to an embodiment of the invention the iodine is added to the remaining electrically insulating oil in the electrical apparatus as a stock solution.

According to an embodiment of the invention the iodine is added by dissolving iodine crystals in the electrically insulating oil in the electrical apparatus.

According to an embodiment of the invention the iodine is added by dissolving iodine crystals in the electrically insulating oil outside of the electrical apparatus.

According to an embodiment of the invention the materials that are to be treated inside the electrical apparatus comprise any from the group of: paper, pressboard, wood and other solid/fibrous insulating materials in contact with the electrically insulating oil

According to an embodiment of the invention the surfaces that are to be treated inside the electrical comprise any from the group of: insulated conductors, exposed conductors, magnetic core and other solid surfaces in contact with the electrically insulating oil.

According to an embodiment of the invention a method is provided that further comprising the step of the iodine is added in the form of iodine vapor.

According to an embodiment of the invention a method is provided that a substantial amount of an electrically insulating oil, normally present in said electrical apparatus, is removed and said iodine is added in the form of iodine vapor.

According to an embodiment of the invention a method is provided that further comprising the step of the treatment with the chemical agent is performed in a controlled atmosphere. The atmosphere is controlled by controlling parameters such as; humidity, temperature, ozone content, nitrogen and oxygen content.

According to an embodiment of the invention a method is provided that further comprising the step of heating the conductors in the electrical apparatus by a current flowing through the conductors during treatment.

According to an embodiment of the invention a method is provided that further comprising the step of subsequent to the treatment with iodine compound, a second treatment with an oxidizing agent is performed. In one embodiment the oxidizing agent comprises ozone (O₃), in another embodiment the oxidizing agent comprises chlordioxide (ClO₂), in yet another embodiment the oxidizing agent comprises peroxy acid (R—O₃H).

According to an embodiment of the invention a method is provided that further comprising the step of subsequent to the treatment with iodine compound, a second treatment with a complex building agent is performed. In one embodiment the complex building agent comprises an organic dibasic amine compound (H₂N—R—NH₂).

According to an embodiment of the invention the oxidizing agent in the second treatment comprises of a mix of oxygen and nitrogen which is added to the controlled atmosphere.

According to an embodiment of the invention, a copper compound, formed as a result of the copper sulphide being treated with said agent, is let to remain on the transformer windings, and that the transformer is re-filled with transformer oil.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a flowchart of one embodiment of the invention.

FIG. 2 is a flowchart of another embodiment of the invention.

FIG. 3 illustrates a schematic process diagram of one method of the invention.

FIG. 4 illustrates a schematic process diagram of one method of the invention.

FIG. 5 is a schematic system view of one embodiment of the present invention.

FIG. 6 is a schematic system view of another embodiment of the present invention.

### DETAILED DESCRIPTION OF THE EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

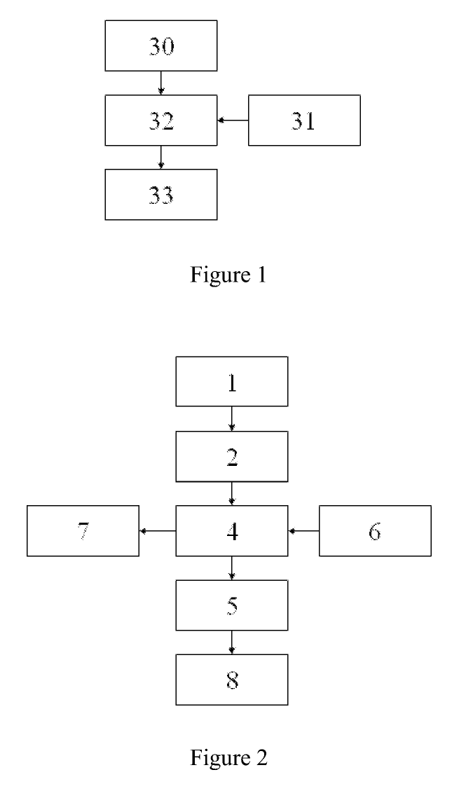

FIG. 1 shows a schematic process diagram of the method. In block 30 the electrical apparatus and the electrically insulating oil is prepared for the treatment. The iodine compound in block 31 is fed into the electrical apparatus and mixed with electrically insulating oil inside the apparatus. In block 32 the substitution reaction (treatment) of the copper sulphide on materials and surfaces inside the electrical apparatus occurs. The reaction transforms the semi conducting copper sulphide on materials and surfaces inside the electrical apparatus to mainly non-conducting copper compounds. In block 33 the excess or un-reacted iodine compound is removed.

FIG. 2 shows a schematic process diagram of one method. In block 1 the electrical apparatus is taken offline. In block 2 the temperature of the oil in the electrical apparatus is adjusted to the optimal temperature for the reaction to occur. From the iodine compound storage (which can be iodine (I₂), hydrogen iodide (HI), alkyl iodide (R—I)) in block 6. The iodine compound is added to the electrically insulating oil in the electrical apparatus and the reaction occurs inside the electrical apparatus in block 4. Excess iodine compound leaving the electrical apparatus during reaction is taken care of in block 7.

Block 5 is the optional second treatment step which can be a treatment with an oxidizing agent such as ozone, chlordioxide or a peroxy acid. The optional second treatment step in block 5 can also be a reaction between the treated copper sulphide and a complex building agent such as an organic dibasic amine compound, with the general chemical formula H₂N—R—NH₂, or an organic compound with at least two organic acid functional groups, with the general chemical formula HOOC—R—COOH. In block 8 the treatment is completed and the electrical apparatus, filled with electrically insulating oil, can be put in operation again.

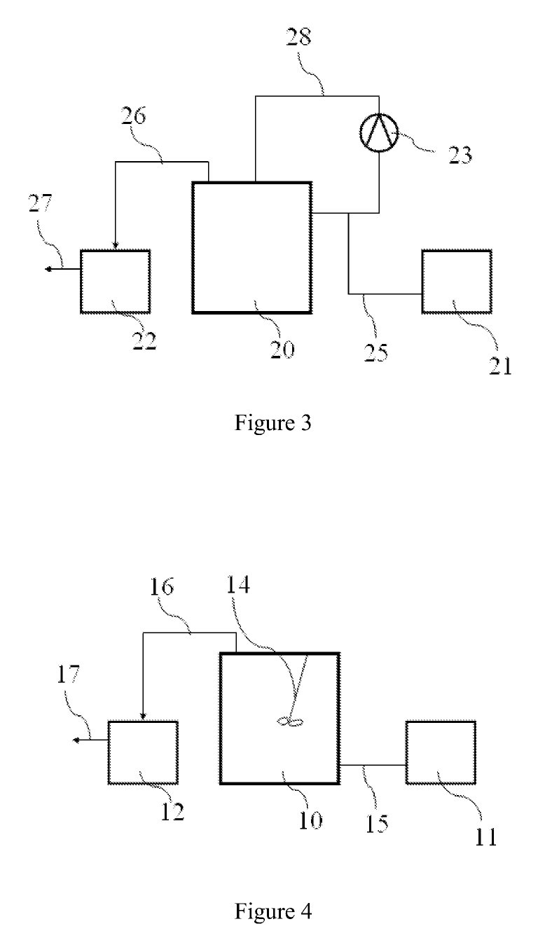

FIG. 3 illustrates a flowchart of one embodiment of the invention. In this flowchart the electrically insulating oil remains inside the electrical apparatus 20 and the treatment can start. An iodine compound storage means 21 supplies the iodine compound for the reaction to occur. The iodine compound is fed 25 into the circulation cycle 28 of the atmosphere in the electrical apparatus 20 and the atmosphere in the apparatus is controlled (with respect to parameters such as; humidity, temperature, nitrogen and oxygen content).

The atmosphere with iodine vapor inside the electrical apparatus 20 that is to be treated has to be well mixed. This mixing assists the diffusion of the iodine onto materials and surfaces inside the electrical apparatus to ensure that the reaction rate is sufficient. In the flowchart one possibility of mixing the atmosphere is shown as a circulation cycle 28 with a pump 23. Un-reacted iodine and excess atmosphere is removed 26 and fed into a cold trap 22 that removes the iodine vapor. The stream leaving the cold trap 22 contains only the excess atmosphere 27.

FIG. 4 illustrates a flowchart of one embodiment of the invention. In this flowchart a substantial amount of the oil remains in the electrical apparatus 10 and the treatment can start. An iodine compound stock solution 11 is used to add the required iodine compound for the reaction to occur. The iodine compound stock solution is fed 15 into the electrical apparatus 10 where it mixes with the remaining oil. The atmosphere over the electrically insulating oil is controlled (with respect to parameters such as; humidity, temperature, nitrogen and oxygen content).

The electrically insulating oil and the stock solution of iodine in the electrical apparatus 10 have to be mixed to assist the diffusion of the iodine onto materials and surfaces inside the electrical apparatus to ensure that the reaction rate is sufficient. In the flowchart one possibility of mixing the oil is shown as an internal mixer 14 inside the electrical apparatus 10. Un-reacted iodine compound evaporates and excess atmosphere is removed 16 and fed into a treatment unit e.g. a cold trap 12 that removes the iodine compound vapor. The stream leaving the cold trap 12 contains only the excess atmosphere 17.

Another way of adding the iodine to the electrically insulating oil is by adding iodine crystals directly to the oil. Yet another way would be to pump the oil in a circulation cycle 28 (FIG. 3) and pass the oil through a bed of iodine crystals and feeding the iodine rich oil back into the apparatus.

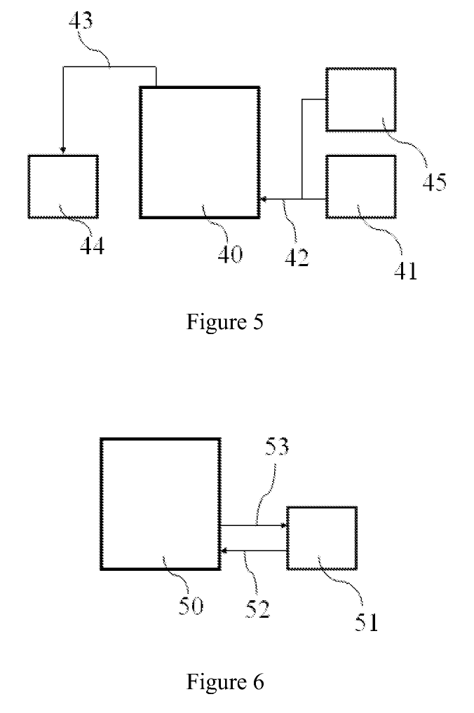

FIG. 5 is a schematic system view of one embodiment of the present invention. The electrical apparatus 40 is filled with electrically insulating oil for electrical protection and heat transfer. From different sources 41, 45 chemical agents are added to the insulating oil. The chemical agents can be in the form of concentrated agent or in the form of agents dissolved in electrical insulation oil. From the source of iodine compound 41 over a feed line 42 to the electrical apparatus 40, the iodine compound is added to the oil. Some oil have to be removed, by a dump line 43 to a storage vessel 44, before the agent, in the form of agents dissolved in electrical insulation oil is added to the electrical apparatus 40, to prevent overflow.

From the source of complex building agent 45, the agent is also fed into the electrical apparatus 40 which is filled with electrically insulating oil. The adding of complex building agent can be performed after the substitution agent (iodine compound) have been added and reacted with copper sulphide on materials and surfaces inside the electrical apparatus. The adding of complex building agent can be performed at the same time as the substitution agent is added. The complex building agent is added in the form of agent dissolved in electrically insulating oil. Some oil have to be removed, by a dump line 43 to a storage vessel 44, before the complex building agent, in the form of agents dissolved in electrical insulation oil is added to the electrical apparatus 40, to prevent overflow.

FIG. 6 is a schematic system view of another embodiment of the present invention. Part of the electrically insulating oil is drawn 53 from the electrical apparatus 50 into a storage vessel 51. In this storage vessel the agent is added to the extracted oil in concentrated form e.g. in liquid form or as crystals. The oil with right amount of agent is fed back 52 into the electrical apparatus 50. In one embodiment the substitution agent is iodine and then the iodine is added to the storage vessel 51 as iodine crystals that slowly dissolves in the electrically insulating oil. The oil in the storage vessel 51 can be stirred or agitated and/or heated to speed up the dissolving of iodine crystals. Similarly the complex building agent can be added to drawn out oil in the form of crystals or stock solution. The oil in the storage vessel 51 is then stirred or agitated and/or heated to generate a uniform agent solution and then fed back into the electrical apparatus 50.

One embodiment of the present invention teaches that the iodine compound is added first and then allowed to react with copper sulphide on materials and surfaces inside the electrical apparatus for some time. When the reaction between the iodine compound and copper sulphide on materials and surfaces in the electrical apparatus 50 is finished, the complex building agent is added to the oil which is fed into the electrical apparatus 50.

Another embodiment of the present invention teaches that the iodine compound is added first and then allowed to react with copper sulphide on materials and surfaces inside the electrical apparatus for some time. When the reaction between the iodine compound and copper sulphide on materials and surfaces in the electrical apparatus 50 is finished, an oxidizing agent is added to the oil which is fed into the electrical apparatus 50.

Another embodiment of the present invention teaches that the iodine compound and the complex building agent are added to the oil in the storage vessel 51 at the same time and then fed into the electrical apparatus 50.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A method of treating copper sulfide deposits on materials and surfaces that are in contact with electrically insulating oil inside an electrical apparatus, the method comprising:
subjecting said copper sulfide deposits on materials and surfaces to treatment with an iodine compound added to the electrically insulating oil in the electrical apparatus and causing a substitution reaction with the copper sulphide, and
oxidizing reaction products from the substitution reaction with an oxidizing agent comprising a compound selected from the list of oxygen, ozone, chlordioxide, and a peroxy acid which is added to electrically insulating oil.

2. The method according to claim 1, wherein said iodine compound comprises iodine (I₂).

3. The method according to claim 1, wherein said iodine compound comprises hydrogen iodide (HI).

4. The method according to claim 1, wherein said iodine compound comprises alkyl iodide (R—I).

5. The method according to claim 2, wherein said iodine is added to electrically insulating oil in the electrical apparatus as a stock solution.

6. The method according to claim 2, wherein said iodine is added by dissolving iodine crystals in the electrically insulating oil in the electrical apparatus.

7. The method according to claim 2, wherein said iodine is added by dissolving iodine crystals in the electrically insulating oil outside of the electrical apparatus.

8. The method according to claim 1, further comprising:
binding the reaction products from the substitution reaction with a complex building agent.

9. The method according to claim 11, wherein said complex building agent comprises an organic dibasic amine compound which is added to electrically insulating oil.

10. A system for treating copper sulfide deposits on materials and surfaces inside an electrical apparatus, the system comprising:
a source for introducing an iodine compound into the electrically insulating oil in said electrical apparatus and the electrical apparatus is adapted to distribute the iodine compound inside said electrical apparatus,
oxidizing agent storage for storing an oxidizing agent, and
a source for introducing the oxidizing agent into the electrically insulating oil in said electrical apparatus, wherein said oxidizing agent comprises a compound from the list of oxygen, ozone, chlordioxide, a peroxy acid.

11. The system according to claim 14, wherein said iodine compound comprises iodine, hydrogen iodide or alkyd iodide.

12. The system according to claim 15, wherein said electrical apparatus comprises a receiver for receiving said iodine compound.

13. The system according to claim 14, further comprising:
complex building agent storage configured to store a complex building agent, and
a source for introducing the complex building agent into the electrically insulating oil in said electrical apparatus.
